(19) United States
(12) Patent Application Publication
(10) Pub. No.: US 2003/0118824 A1
(43) Pub. Date: Jun. 26, 2003

(54) Coated silica particles and method for production thereof

(76) Inventors: Bozena Stanislawa Tokarz, Kungalv (SE); Kenneth Olof Larsson, Goteborg (SE)

Correspondence Address: Michelle Burke, Akzo Nobel Inc., 7 Livingstone Avenue, Dobbs Ferry, NY, 10522, US

(21) Appl. No.: 10/323,089

(22) Filed: Dec. 19, 2002

Related U.S. Application Data
(60) Provisional application No. 60/344,313, filed on Dec. 20, 2001.

(51) Int. Cl. B32B 5/16

(52) U.S. Cl. 428/404; 428/403; 428/446

(57) ABSTRACT

The present invention relates to a method for preparing cerium oxide coated silica particles and cerium oxide silica particles obtainable by the method. The invention further relates to cerium oxide coated silica particles and the use thereof for polishing.

The present invention relates to cerium oxide coated silica particles, a method for providing such particles, and the use thereof for e.g. polishing applications.

### BACKGROUND OF THE INVENTION

Use of silica sols in compositions for polishing applications is known in the art. This is described e.g. in WO99/32570. However, silica sols are not always satisfyingly effective for this application. Standard silica sols may also contain impurities which may come in direct contact with sensitive electronic components such as semiconductors to be polished.

It would be desirable to provide silica particles having improved properties especially for polishing applications. Furthermore, it would be desirable to provide cost-effective material which is particularly suitable for polishing applications. It would further be desirable to provide silica particles having improved properties for other applications such as additives in coatings, ceramics, paints, and catalysts. It would further be desirable to provide a simple but efficient method comprising a minimal number of steps and raw materials for providing improved silica particles for these applications. It would further be desirable to provide a method that instantly or after a very short period of time brings about the desired product to avoid long reaction times. The provision of polishing agents may be the bottle neck that delays the whole manufacturing process of electronic devices in which the polished electronic components are mounted. The present invention intends to solve the drawbacks of the prior art and provides the desired product.

### THE INVENTION

The present invention relates to a method for preparing cerium oxide coated silica particles comprising preparing a dispersed mixture comprising silica particles, at least one cerium containing precursor, and an oxidising agent, thereby oxidising the at least one cerium containing precursor to form at least one cerium oxide on the silica particles.

It has been found that substantially all cerium content added as cerium containing precursor is oxidised to form at least one cerium oxide which deposits substantially entirely on the silica particles. This is surprising because it can be supposed that some cerium oxide would precipitate on the bottom of the reactor in which the oxidation reaction occurs. It is therefore believed that the silica particles may attract forming cerium oxide so as to deposit on the surface of the silica particles as the oxidation reaction proceeds. This possible phenomenon is of course favourable because loss of cerium content as a precipitate on the bottom of the reactor is minimised. A further advantage accompanied with this method is the short reaction time, i.e. the time elapsed from the moment of mixing the cerium containing precursor with the further components in the dispersed mixture until substantially all of the cerium containing precursor has been oxidised and deposited on the silica particles. The coating of the silica particles occurs virtually instantly.

It is therefore an advantage that the coating of cerium oxide is carried out directly on the silica particles without any further intermediate layer between the silica particles and the cerium oxide, e.g. metal layers of titania or zirconia or mixtures of metal layers, which intermediate layers may make the deposition of formed cerium oxide on the silica particles smaller and more difficult.

By the term “cerium containing precursor” is meant any cerium containing compound which is liable to form a cerium oxide on silica particles. Such precursors include e.g. metallic cerium, cerium salts such as cerium(III) acetate, cerium(III) acetate hydrate, cerium(III) bromate, cerium(III) fluoride, cerium(III) chloride, cerium(III) iodate, cerium(III) iodide, cerium(III) nitrate such as Ce(NO₃)₃.6H₂O or cerium oxide nitrate, ceric ammonium nitrate, cerium(III) oxalate, cerium(III) 2,4-pentanedione, cerium(III) metophosphate, cerium(III) orthophosphate, cerium(III) salicylate, cerium(III) selenate, cerium(III) sulfate, hexaantipyrinecerium(III) iodide, preferably cerium(III) nitrate or cerium(III) sulfate.

If for example cerium(III) nitrate is mixed with a dispersion of silica particles and an oxidizing agent in accordance with the present invention, the Ce³⁺ ion which is easily soluble in an aqueous phase can be oxidized to Ce⁴⁺ ion due to the presence of the oxidising agent. In contrast to the Ce³⁺ ion, the Ce⁴⁺ ion is considerably less water soluble. It has been found that the difference in solubility between the different oxidation states can advantageously be utilised to form cerium oxide on silica particles. Cerium oxide can instantly deposit on the silica particles in presence of an oxidizing agent such as hydrogen peroxide, suitably in alkaline pH in the presence of e.g. ammonium hydroxide, according to the formula below:

Ce(NO₃)₃+1/2H₂O₂+3NH₄OH→CeO₂+2H₂O+3NH₄NO₃

By the term “cerium oxide” is here meant to comprise cerium oxide-based complexes including e.g. alkoxides, hydroxides, oxyhydroxides, cerium hydrates and any other cerium and oxygen containing compound. The oxidation state of the cerium in the cerium oxide is not necessarily an integer but may be between two integers 3 and 4. This is due to the formation of various cerium oxide hydro complexes which may incorporate water molecules.

The oxidising agent may be e.g. hydrogen peroxide, elemental oxygen, oxygen, ozone, hypochlorite, hypobromide or other halogens or oxidised halogen compounds, or mixtures thereof, preferably hydrogen peroxide. Preferably, the oxidising agent is present in an aqueous dispersion.

Suitably, the inventive method is carried out in alkaline environment, i.e. at a pH higher than about 7. Suitable alkaline solutions include ammonia, alkali metal hydroxide such as sodium hydroxide, potassium hydroxide, lithium hydroxide, ammonium hydroxide, amines, quaternary hydroxides as well as other nitrogen containing alkaline compounds and mixtures thereof. Preferably, at least when preparing cerium oxide coated silica particles for specific polishing applications such polishing of hard discs and processors, the alkaline solution is substantially free of sodium, since some materials are extremely sensitive to sodium.

For reasons of simplicity, the term “silica sol” will be used in the description to describe further preferred embodiments. However, silica particles derived from fumed silica, precipitated silica, silanes, siloxanes, or silica gels with sufficient purity may also be used to provide the cerium oxide coated silica particles.

By the terms “silica sol” and “silica particle” are herein meant any type of silica sol or silica particle including e.g. aluminium or boron modified silica sol or silica particle. Boron-modified silica sols are described in e.g. U.S. Pat. No. 2,630,410. Aluminium modified silica sols, sometimes also referred to as aluminate modified silica sols, can be prepared by adding an appropriate amount of aluminate ions, Al(OH)₄⁻, suitably of a diluted sodium or potassium aluminate solution. This is described in e.g. “The Chemistry of Silica”, by Iler, K. Ralph, pages 407-409, John Wiley & Sons (1979) and in U.S. Pat. No. 5,368,833. Preferably, an aqueous silica sol is used. However, other silica sols dispersed in other media may also be used, such as amine sols or the like.

Alkaline solutions as mentioned herein may also be employed to stabilise dispersed silica particles. Such stabilised silica particles suitably have a pH from about 5 to about 12. The silica particles suitably have a particle size ranging from about 1 to about 200, preferably from about 5 to about 100, and most preferably from about 10 to about 30 nm. The size of the oxide particles is important in some applications, especially when the silica particles are used to polish e.g. wafers or other electronic component since large particles, especially in the size range of μm easily may cause scratches and other detrimental effects on the treated element. Particles of the preferred size range may also be important when glass or other optical material is treated which must keep its planarity. Treatment with silica particles with the preferred particle sizes also result in a more even topography of the treated materials.

According to a preferred embodiment, the silica particles are substantially monodisperse, i.e. they have a particle size distribution which is fairly narrow. Suitably, the silica particles have a relative standard deviation of the particle size distribution lower than about 15% by numbers, preferably lower than 10% by numbers, and most preferably lower than about 8% by numbers. The relative standard deviation of the particle size distribution is the ratio between the mean particle size by numbers and the standard deviation of the particle size distribution.

The reaction temperature under which the oxidation reaction occurs suitably ranges from about 10 to about 60° C., preferably from about 25 to about 40° C., and most preferably from about 30 to 35° C. The reaction mixture is suitably agitated to provide a homogeneous solution.

According to one preferred embodiment, the obtained cerium oxide coated silica particles are subjected to a separation step to wash out any possible excess of electrolyte. Such separation may be performed by e.g. ultrafiltration, decantation, or centrifugation.

The invention further relates to a cerium oxide coated silica particle obtainable by the method as described herein.

The invention also relates to cerium oxide coated silica particles comprising at least one cerium oxide. By the term “cerium oxide” is here meant to comprise cerium oxide-based complexes including e.g. alkoxides, hydroxides, oxyhydroxides, cerium hydrates or any other cerium and oxygen containing compound. The oxidation state of the cerium in the cerium oxide is not necessarily an integer but may be between two integers 3 and 4. By cerium oxide coated silica particles comprising at least one cerium oxide is meant cerium oxide deposited directly on the silica particles, i.e. not deposited on other intermediate layers such as metal layers or metal oxide layers between the cerium oxide and the silica particle as defined herein. The deposition of cerium oxide directly on the silica particles results in high deposition of cerium oxide which of course is advantageous.

The cerium oxide coated silica particles provide advantageous physical and chemical properties, especially for polishing applications but also as an additive to coatings, paints, ceramics and the like. The cerium oxide coating may be present in crystalline or amorphous form or mixture thereof. The cerium oxide coated silica particles may be provided in any size since the polymerisation of the silica particles may be easily controlled. A combination of different particle sizes of cerium oxide coated silica particles may if necessary be prepared for certain applications. The cerium oxide coated silica particles also benefit from a long term stability, particularly in the pH range 6-13, which is necessary in many applications. This is due to the fact that the pH, viscosity, and density may remain substantially constant in the course of time.

Preferably, cerium oxide is evenly distributed on the particles in an amount from about 100 to about 5000, and most preferably from about 100 to about 1000 μg cerium oxide/m² specific surface area of the silica particle. It has been found that the “removal rate” caused by the polishing agent in polishing applications is higher for cerium oxide coated silica particles than for conventional silica particles.

Preferably, the size of the coated silica particles is from about 1 to about 200, preferably from about 5 to about 100, and most preferably from about 10 to about 30 nm. Particles smaller than about 100 nm are thus preferred because these can provide improved polishing results without scratching the polished material. Sizes smaller than 100 nm are also suitable when the cerium oxide coated silica particles are used as additives in paints, coatings, and ceramics. Topography and evenness at atom level may almost be reached.

Suitably, the cerium oxide coated silica particles are dispersed in an aqueous phase thereby forming an aqueous silica sol. Preferably, the amount of silica particles in the aqueous silica sol range from about 1-50 wt %, more preferably from about 1-30 wt %. Preferably, the concentration of cerium oxide distributed on the surface of the silica particles is from about 0.1 to about 15 wt %, preferably from about 1 to about 10 wt %, and most preferably from about 2 to about 7 wt % based on the solid content of the silica particles.

According to one preferred embodiment, at least one cerium oxide is deposited directly on the silica of the silica particles. This means that cerium oxide is deposited directly on the silica without any intermediate, e.g. metal layers such as titania or zirconia or mixtures of different metal or metal oxide layers or other groups or atoms, between the silica and the cerium oxide. Preferably, the cerium oxide coated silica particles do not comprise further metal or metal oxide layers such as e.g. titania or zirconia or mixtures thereof. Further characteristics of the cerium oxide coated silica particles and the silica particles per se are as described herein.

The present invention also regards the use of the cerium oxide coated silica particles as described herein for polishing. Particularly, the present invention relates to a polishing composition comprising cerium oxide coated silica particles. Polishing includes e.g. mechanical wafer polishing or chemical-mechanical polishing of electric components such as semiconductors in the electronic industry, polishing of glass and other optical material etc, preferably wafer polishing. The cerium oxide coated silica particles are suitably used in a polishing composition which may contain NH₄OH and a complexing agent, suitably a sequestering agent, preferably a chelating agent. A sequestering agent is a substance that removes e.g. a metal ion from a solution by forming a complex ion that does not have the chemical reactions of the metal ion that is removed, whereas a chelating agent is an organic compound forming more than one co-ordinate bond with metals in a solution. Preferred chelating agents include a plurality of substituted acetic acid groups, and may e.g. be chosen from a group comprising ethylenediaminetetraacetic acid (EDTA), diethylenetriaminepentaacetic acid (DTPA), N-(hydroxoethyl) ethylene-diamintriacetic acid (HEDTA), and nitrilo triacetic acid (NTA), or a combination thereof.

The cerium oxide coated silica particles may also be used as additive in coatings in ceramics, paints and catalysts, especially in the coating industry.

The invention being thus described, it will be obvious that the same may be varied in many ways. Such variations are not to be regarded as a departure from the gist and scope of the present invention, and all such modifications as would be obvious to one skilled in the art are intended to be included within the scope of the claims. The following example will further illustrate how the described invention may be performed without limiting the scope of it. If not otherwise stated, all parts and percentages refer to parts and percent by weight.

### EXAMPLE 1

400 g of a diluted silica sol (Bindzil 50/80) was placed in a glass reactor and heated to 50° C. Thereupon, the following reagents were added under vigorous agitation to provide a reaction mixture: 25 g cerium nitrate, 4 g H₂O₂ in a 50 wt % aqueous solution, 20 g of pure ammonia in an ammonia solution. An ultrafiltration unit (Lab 10-modul) was run at the same time to wash out formed ammonium nitrate.

The silica sol immediately changed colours on addition of the further reagents. Colourless cerium(III) nitrate solution contacted with H₂O₂ turned brownish yellow and with time, as the cerium(IV) oxide concentration increased, the brownish yellow colour became more intensive. The change in colour is evidence of the oxidation of Ce³⁺ to Ce⁴⁺. Subsequently, analysis was carried out by means of TEM (transmission electronic microscopy), XPS (X-ray photon spectroscopy), and ICP (Inductive coupled plasma) which showed that all formed cerium oxide had deposited on the silica particles to form a homogeneous layer thereon.

1. Method of preparing coated silica particles comprising preparing a dispersed mixture of silica particles, at least one cerium containing precursor, and an oxidising agent, thereby oxidising said at least one cerium containing precursor to form cerium oxide coated silica particles with at least one cerium oxide on the silica particles.

2. Method according to claim 1, wherein the silica particles are colloidal silica particles.

3. Method according to claim 1, wherein the dispersed mixture is prepared in an alkaline dispersion.

4. Method according to claim 1, wherein the oxidising agent is hydrogen peroxide.

5. Method according to claim 1, wherein the dispersed mixture containing the cerium oxide coated silica particles is subsequently subjected to a separation step to wash out any excess of cerium containing precursor.

6. Method according to claim 1, wherein the at least one cerium containing precursor is selected from at least one of metallic cerium or cerium salts.

7. Method according to claim 1, wherein the silica particles have a relative standard deviation of the particle size distribution lower than about 15% by numbers.

8. Method of preparing cerium oxide coated silica particles which comprises mixing silica particles, at least one cerium containing precursor, and an oxidising agent.

9. Cerium oxide coated silica particles obtained by preparing a dispersed mixture of silica particles, at least one cerium containing precursor, and an oxidising agent.

10. Cerium oxide coated silica particles.

11. Cerium oxide coated silica particles according to claim 10, wherein the silica particles are colloidal silica particles.

12. Cerium oxide coated silica particles according to claim 10, wherein cerium oxide is distributed on the silica particles in an amount from about 100 to about 5000 μg cerium oxide/m² specific surface area of a silica particle.

13. Cerium oxide coated silica particles according to claim 10, wherein the silica particles have a relative standard deviation of the particle size distribution lower than about 15% by numbers.
